(19) United States
(12) Patent Application Publication
(10) Pub. No.: US 2011/0155878 A1
(43) Pub. Date: Jun. 30, 2011

(54) FIXING DEVICE

(75) Inventor: SONG-YA CHEN, Shenzhen City (CN)

(73) Assignees: FU TAI HUA INDUSTRY (SHENZHEN) CO., LTD., ShenZhen City (CN); HON HAI PRECISION INDUSTRY CO., LTD., Tu-Cheng (TW)

(21) Appl. No.: 12/887,470

(22) Filed: Sep. 21, 2010

(30) Foreign Application Priority Data
Dec. 30, 2009 (CN) 200910312820.3

(51) Int. Cl. F16M 13/02

(52) U.S. Cl. 248/225.21; 248/205.1

(57) ABSTRACT

A fixing device for fixing a first element to a second element is provided. The fixing device includes a post, at least one latching member and an operating member. The post includes a head portion and an end portion. The head portion has a biasing member for generating a compressive force. The end portion defines a chamber with an opening portion defined on a sidewall of the chamber. The at least one latching member is disposed within the chamber. Each latching member has a hook portion extending out laterally. The hook portion is disposed within the opening portion and slides into and out of the chamber through the opening portion. The operating member drives the hook portion to slide into and out of the chamber.

### BACKGROUND

1. Technical Field

The present disclosure relates to fixing devices, and particularly to a fixing device for securing a first element to a second element.

2. Description of Related Art

A number of conventional fasteners, such as heat sink fasteners, are used to attach a first element to a second element. The fasteners extend through clearance holes in the first and second elements, and are constructed to exert a spring force that presses the first element against the second element. The fasteners that are presently used to fasten the first element to the second element are relatively difficult to assemble. Therefore, there is room for improvement in the art.

### BRIEF DESCRIPTION OF THE DRAWINGS

The components of the drawings are not necessarily drawn to scale, the emphasis instead being placed upon clearly illustrating the principles of a fixing device. Moreover, in the drawings, like reference numerals designate corresponding parts throughout several views.

FIG. 1 is an isometric view of a fixing device in accordance with an exemplary embodiment.

FIG. 2 is an exploded, perspective view of the fixing device of FIG. 1.

FIG. 3 is another isometric view of the fixing device of FIG. 1, showing the fixing device in a contracted state.

FIG. 4 is a cross-sectional view of the fixing device of FIG. 3, taken along line IV-IV.

FIG. 5 is a cross-sectional view taken along line V-V of FIG. 3.

FIG. 6 is a schematic view showing the fixing device employed to fixing a first element to a second element.

FIG. 7 is another isometric view of the fixing device of FIG. 1, showing the fixing device in an elongated state.

### DETAILED DESCRIPTION

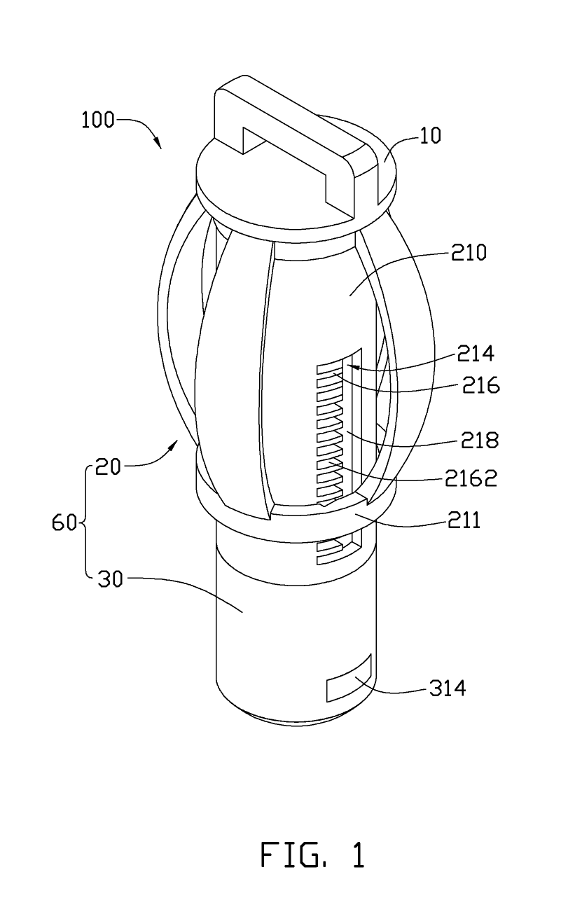

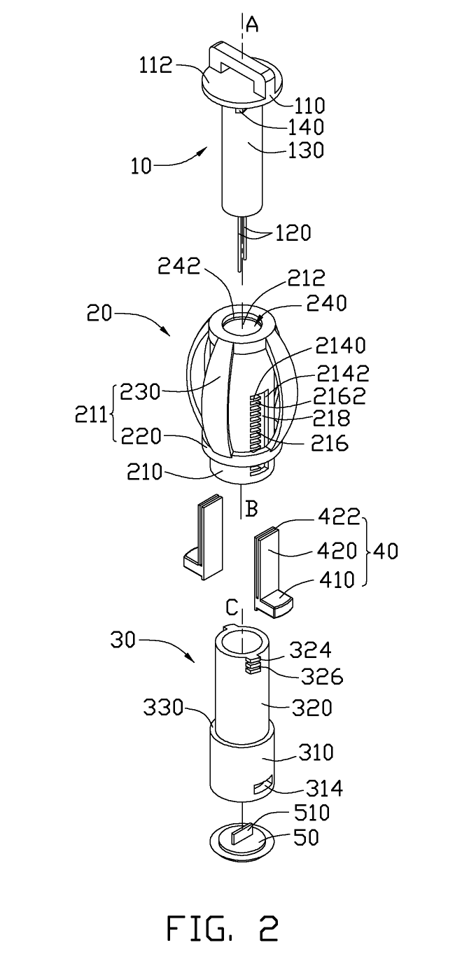

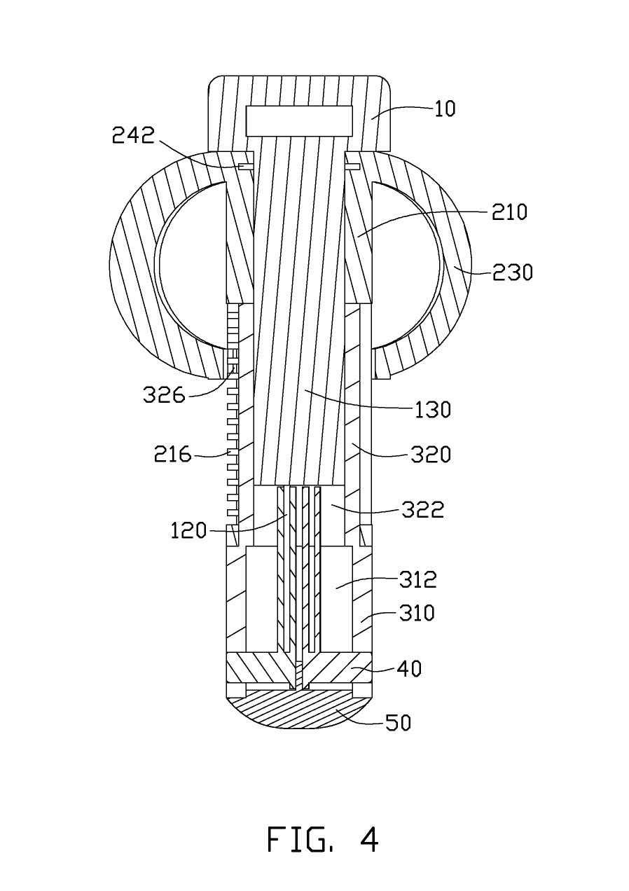

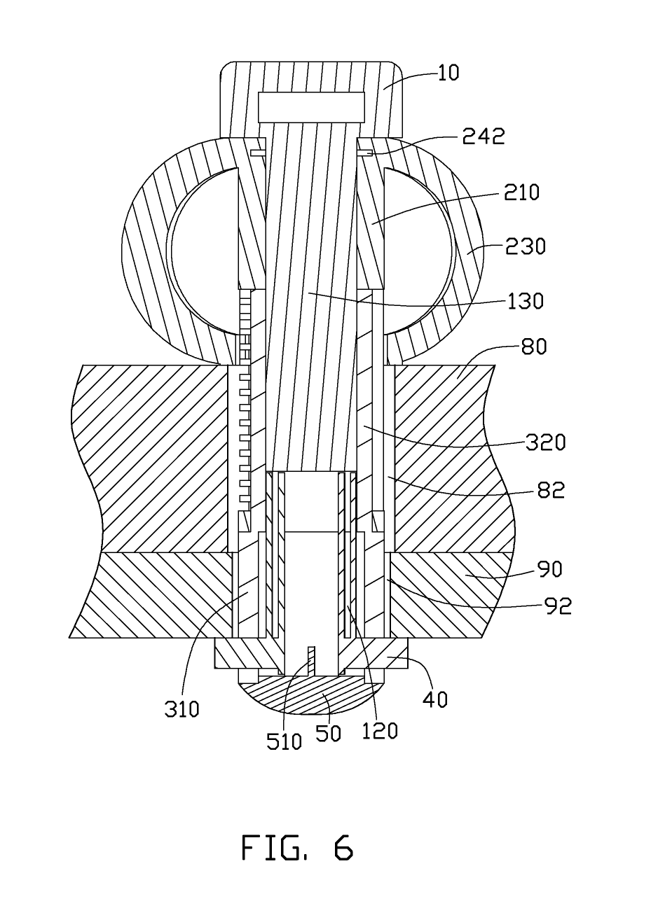

Referring to FIGS. 1-2, an embodiment of a fixing device 100 is illustrated. The fixing device 100 is employed to secure a first element, such as a heat sink, to a second element such as a main board of a computer (see FIG. 6). The fixing device 100 includes an operating member 10, a post 60, and a pair of latching members 40. The post 60 defines a longitudinal receiving space therein. The receiving space includes a first receiving space 212, a second receiving space 312 and a third receiving space 322 (see FIG. 4). The post 60 includes a first tube 20 and a second tube 30 partially and coaxially nested in the first tube 20. The operating member 10 is capable of rotating within the receiving space around its own axis. The latching members 40 can move with respect to the second tube 30, thus the latching members 40 are capable of selectively extending out of and being received in the second tube 30. The operating member 10 is further moveably connected to the latching members 40 to drive the latching members 40 to extend out of and be received in the second tube 30.

The operating member 10 includes a knob 110, two rods 120, and a connecting member 130 connecting the knob 110 with the rods 120. The knob 110 includes a stopper plate 112. In this embodiment, the stopper plate 112 is substantially circular. The connecting member 130 is a cylinder. One end of the connecting member 130 is attached to the stopper plate 112. The diameter of the connecting member 130 is less than that of the stopper plate 112. The rods 120 extend longitudinally from an opposite end of the connecting member 130, and are symmetrically relative to an axis A of the connecting member 130. A block 140 further protrudes from the sidewall of the connecting member 130 adjacent to the knob 110.

The first tube 20 includes a main body 210, a slidable element 220 slidably sleeves on the main body 210, and elastic elements 230 connecting the main body 210 to the slidable element 220. The slidable element 220 and the elastic elements 230 are considered to be a biasing member 211. When the fixing device 100 is used to fix the first element and the second element, the biasing member 211 is used to generate compressive force to compress the first element and the second element against the latching members 40.

In this embodiment, the main body 210 is substantially cylindrical. The main body 210 defines the first receiving space 212 extending along an axis B of the main body 210 to receive the connecting member 130. The diameter of the first receiving space 212 is greater than that of the connecting member 130, but less than that of the stopper plate 112, thus the connecting member 130 can be rotated in the first receiving space 212, and the stopper plate 112 can be operable to rotate with the connecting member 130.

The main body 210 further defines a pair of openings 214 (see FIG. 1) symmetrically arranged relative to the axis B and communicating with the first receiving space 212. The openings 214 are adjacent to an end of the main body 210 away from the knob 110. In this embodiment, each opening 214 is substantially rectangular, and includes a first sidewall 2140 and a second sidewall 2142 opposite to the first sidewall 2140. Hereinafter, in order to specifically illustrate the present disclosure, the openings 214 are respectively referred to a first opening and a second opening. The first sidewall 2140 of the first opening and the second sidewall 2142 of the second opening are symmetrically arranged relative to the axis B, and the second sidewall 2142 of the first opening and the first sidewall 2140 of the second opening are symmetrically arranged relative to the axis B. Two columns of projections 216 respectively protrude from the first sidewall 2140 of the first opening and the second sidewall 2142 of the second opening. Two adjacent projections 216 in each column are spaced by the same distance to form a first latching slot 2162.

A pair of sliding slots 218 is respectively formed in the first opening and the second opening. The projections 216 on the first sidewall 2140 of the first opening and the second sidewall 2142 of the first opening are spaced by a distance to form one of the sliding slots 218, and the projections 216 on the second sidewall 2142 of the second opening and the first sidewall 2140 of the second opening are spaced by a distance to form another sliding slot 218.

A groove 242 is further formed in the sidewall of the first receiving space 212 to receive the block 140. In this embodiment, the groove 242 is substantially annular. The block 140 can slide in the groove 242 to avoid the operating member 10 separating from the first receiving space 212.

In this embodiment, the slidable element 220 is substantially annular. The inner diameter of the slidable element 220 is slightly greater than the diameter of the main body 210, thus the slidable element 220 can sleeve on the main body 210. The number of the elastic elements 230 is four. One end of each elastic element 230 is attached to the end of the main body 210 adjacent to the knob 110, and an opposite end is attached to the slidable element 220, thus the slidable element 220 can slide along the main body 210 under the restoring force of the elastic elements 230. The elastic elements 230 are symmetrically arranged relative to the axis B. The number of the elastic elements 230 can vary according to user's requirements.

The second tube 30 includes a larger barrel 310 and a smaller barrel 320 connected to and coaxial to the larger barrel 310. The diameter of the larger barrel 310 is greater than that of the smaller barrel 320, such that a shoulder 330 is formed in a connecting position of the larger barrel 310 and the smaller barrel 320. The diameter of the larger barrel 310 is substantially equal to that of the main body 210. The diameter of the smaller barrel 320 is less than that of the first receiving space 212, and the smaller barrel 320 is rotatably received in the first receiving space 212, whereby the second tube 30 partially and coaxially nested in the first tube 20.

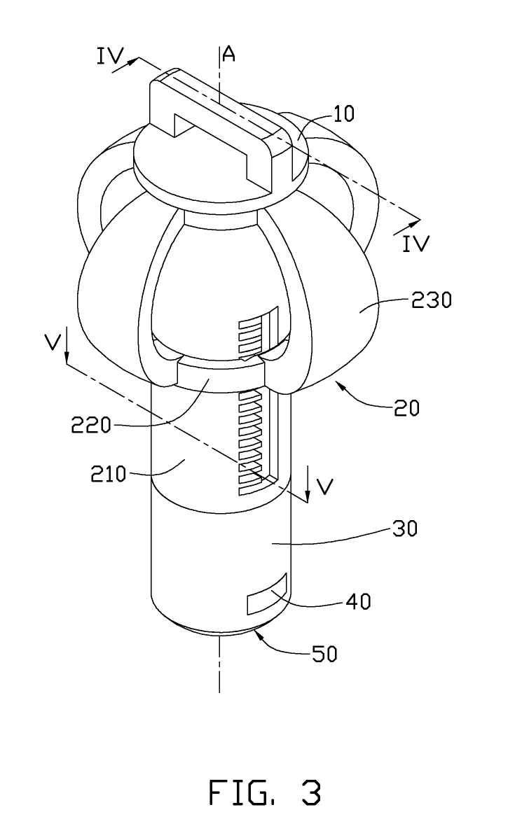

Referring to FIGS. 3-4, the larger barrel 310 defines the second receiving space 312, and the smaller barrel 320 defines the third receiving space 322 coaxial to and communicating with the second receiving space 312. The diameter of the second receiving space 312 can be the same as or different from that of the third receiving space 322. The diameter of the third receiving space 322 is slightly greater than that of the connecting member 130, such that the connecting member 130 can be received in the third receiving space 322. The larger barrel 310 defines a pair of guide holes 314 symmetrically arranged relative to an axis C of the larger barrel 310 and away from the smaller barrel 320.

Two columns of protrusions 324 (see FIG. 2) protrude from the smaller barrel 320 and are symmetrically about the axis C and away from the larger barrel 310. In this embodiment, the number of the protrusions 324 in each column is three. Two adjacent protrusions 324 in each column are spaced the same distance apart to form a second latching slot 326. The height of each protrusion 324 is slightly less than or equal to the depth of each first latching slot 2162. And the depth of each projection 216 is slightly less than or equal to the depth of each second latching slot 326, such that the protrusions 324 can engage the projections 216 to secure the second tube 30 to the first tube 20. The distance between the free end of each protrusion 324 in one column and the free end of one substantially parallel protrusion 324 in another column is substantially equal to or slightly less than the diameter of the main body 210. Such that the protrusions 324 do not extend out of the openings 214, and the slidable element 220 can slide along the main body 210.

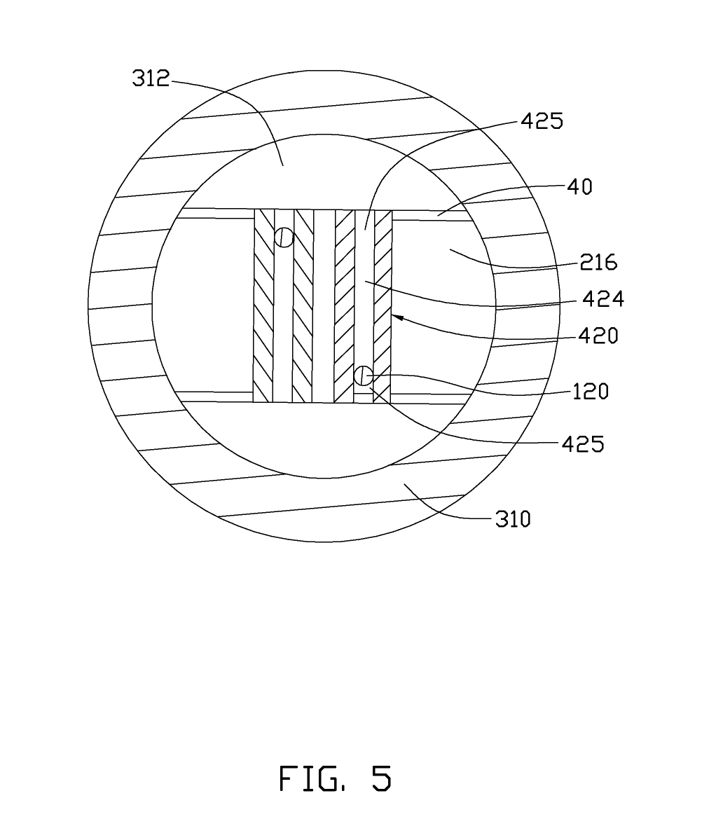

Referring to FIG. 5, each latching member 40 is substantially L-shaped. Each latching member 40 includes a hook portion 410 (FIG. 2) and two plates 420 extending upwardly from the hook portion 410 with an interval 422 defined by the two plates 420. Each hook 410 can be received in one guide hole 314. The interval 422 is used to slidably receive one rod 120. Each interval 422 includes two opposite distal ends 425 and a middle portion 424 arranged between the distal ends 425.

The fixing device 100 further includes a base 50 (FIG. 4) secured to the end of the larger barrel 310 away from the smaller barrel 320. The base 50 is substantially circular, and the diameter of the base 50 is slightly less than the inner diameter of the larger barrel 310. A stopper portion 510 (FIG. 6) protrudes from a surface of the base 50.

When assembling the fixing device 100, the latching members 40 are placed in the second receiving space 312 and each hook portion 410 is received in one guide hole 314.

The base 50 is attached to the larger barrel 310 to cause the stopper portion 510 to be arranged between the latching members 40. The first tube 20 is arranged over the smaller barrel 320 to cause the protrusions 324 to engage the projections 216 adjacent to the knob 110. The connecting member 130 is placed in the first receiving space 212 to cause the block 140 to be received in the groove 242 and cause each rod 120 to be received in corresponding interval 422. The knob 110 is then rotated to cause each rod 120 to move to one distal end of each interval 422. At this point, the hook portions 410 are received in the guide holes 314 respectively.

After assembly, the connecting member 130, the main body 210, the smaller barrel 320, and the larger barrel 310 are coaxial to each other. The elastic elements 230 are in a natural state. The protrusions 324 engage the projections 216 adjacent to the knob 110. The hook portions 410 are received in the through holes 314.

FIG. 6 expresses how to use the fixing device 100 to secure the fan 80 to the main board 90. The fan 80 defines a number of first through holes 82, and the main board 90 defines a number of second through holes 92. Each first through hole 82 and each second through hole 92 can receive the larger barrel 310. The diameters of each first through hole 82 and each second through hole 92 are less than that of the slidable element 220. The total of the depth of each first through hole 82 and each second through hole 92 is less than the distance between the slidable element 220 and one guide hole 314. When the fixing device 100 secures the fan 80 to the main board 90, the larger barrel 310 is inserted into one first through hole 82 and one second through hole 92 in sequence until the slidable element 220 resists the fan 80. At this point, the knob 110 is pressed downward to cause the elastic elements 230 to be compressed and cause the larger barrel 310 to move downward until the guide holes 314 are exposed to the second through hole 92. At this point, the knob 110 is rotated to cause each rod 120 to move from the distal end 425 to the middle portion 424 of each interval 422. The movement of each of the rods 120 from the distal end 425 to the middle 424 causes the hook portions 410 to extend out of the guide holes 314 and hook the main board 90. The knob 110 is then released, and the elastic elements 230 rebound to cause the slidable element 220 to press the fan 80. At this point, the fan 80 and the main board 90 are secured between the hook portions 410 and the slidable element 220.

To separate the fan 80 from the main board 90, the knob 110 is rotated toward an opposite direction to cause each of the rods 120 to move from the middle portion 424 to the distal end 425. The movement of each of the rods 120 from the middle portion 424 to the distal end 425 causes the hook portions 410 to be received in the guide holes 314. The knob 110 is then released, and the elastic elements 230 rebound. At this point, the fixing device 100 can be easily pulled out of the second through hole 92 and the first through hole 82.

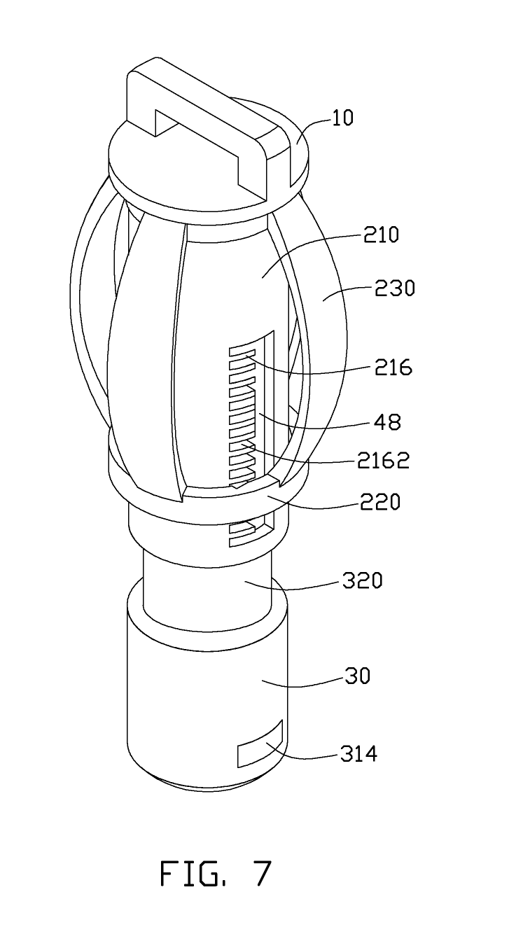

Referring also to FIG. 7, if the total of the depth of the first through hole 82 and the second through hole 92 is larger than the total of the height of the main body 210 and the height of the larger barrel 310. The second tube 30 is rotated to cause the protrusions 324 to disengage from the projections 216 and move into the sliding slots 218. The second tube 30 is then pulled downward a certain distance until the fixing device 100 is fit to secure the fan 80 to the main board 90. The second tube 30 is then rotated to cause the protrusions 324 to engage the projections 216 to secure the second tube 30 to the first tube 20. At this point, the second tube 30 can be employed to secure the fan 80 to the main board 90.

With such configuration, the length of the fixing device 100 can be adjusted according to need, thus the fixing device 100 is fit to secure elements having different length through holes.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A fixing device for fixing a first element to a second element, the fixing device comprising:
a post having a head portion and an end portion, the head portion having a biasing member for generating a compressive force, the end portion defining a chamber with an opening portion defined on a sidewall of the chamber;
at least one latching member disposed within the chamber, each latching member having a hook portion extending out laterally, the hook portion being disposed within the opening portion and being capable of sliding into and out of the chamber through the opening portion; and
an operating member configured for driving the hook portion to slide into and out of the chamber.

2. The fixing device as claimed in claim 1, wherein the post defines a longitudinal through hole, and the operating member is coaxially disposed within the though hole from the head portion and is engaged with the at least one latching member for driving the at least one latching member to move laterally.

3. The fixing device as claimed in claim 2, wherein the operating member is capable of rotating within the through hole around its own axis.

4. The fixing device as claimed in claim 3, wherein the operating member comprises at least one rod extending downwardly and longitudinally, and the at least one rod is spaced from the axis line, the at least one rod is engaged with the at least one latching member such that when the operating member is rotating around its own axis in the through hole, the at least one latching member is driven by the at least one rod to slide laterally.

5. The fixing device as claimed in claim 4, wherein each latching member comprises two plates extending upwardly with an interval defined by the two plates, the at least one rod is inserted into the interval.

6. The fixing device as claimed in claim 5, wherein the interval defined by the two plates of each latching member comprises a pair of distal ends and a middle portion between the distal ends, the movement of the operating member from one of the distal ends to the middle portion drives the hook portion to extend out of the opening portion, and the movement of the operating member from the middle portion to other one of the distal ends drives the hook portion to be received in the opening portion.

7. The fixing device as claimed in claim 1, wherein the post is extensible/retractable.

8. The fixing device as claimed in claim 7, wherein the post comprises a first tube and a second tube partially and coaxially nested in the first tube, the second tube is capable of moving longitudinally and circumferentially relative to the first tube.

9. The fixing device as claimed in claim 8, wherein the first tube defines at least one latching slot and at least one column of projections, each of the at least one column of projections communicating with one of the at least one latching slot, the second tube defines at least one column of protrusions, each of the at least one column of protrusions being able to slide in one of the at least one latching slot, and being able to engage one of the at least one column of the projections to secure the second tube to the first tube.

10. A fixing device for fixing a first element to a second element, the fixing device comprising:
a post comprising a first tube and a second tube partially and coaxially nested in the first tube, the second tube being capable of moving longitudinally and circumferentially relative to the first tube;
at least one latching member arranged at one end of the second tube opposite to the first tube; and
a biasing member fixed to an end of the first tube opposite to the second tube and for generating a compressive force, the biasing member used for compressing the first element and the second element against the at least one latching member, whereby the first element is fixed to the second element;
wherein when the second tube moves longitudinally relative to the first tube, the length of the post is adjustable.

11. The fixing device as claimed in claim 10, wherein the first tube defines at least one latching slot and at least one column of projections, each of the at least one column of projections communicating with one of the at least one latching slot, the second tube defines at least one column of protrusions, each of the at least one column of protrusions being able to slide in one of the at least one latching slot, and being able to engage one of the at least one column of the projections to secure the second tube to the first tube;

12. The fixing device as claimed in claim 11, wherein the second tube further defines a chamber with an opening portion defined on a sidewall of the chamber, the at least one latching member is disposed within the chamber, each latching member has a hook portion extending out laterally, the hook portion is disposed within the opening portion and is capable of sliding into and out of the chamber through the opening portion.

13. The fixing device as claimed in claim 12, further comprising an operating member configured for driving the hook portion to slide into and out of the chamber.

14. The fixing device as claimed in claim 13, wherein the first tube and the second tube cooperatively defines a coaxial through hole communicating with the chamber, the operating member is coaxially disposed within the though hole from the first tube and is engaged with the at least one latching member for driving the at least one latching member to move laterally.

15. The fixing device as claimed in claim 14, wherein the operating member is capable of rotating within the through hole around its own axis.

16. The fixing device as claimed in claim 15, wherein the operating member comprises at least one rod extending downwardly and longitudinally, and the at least one rod is spaced from the axis line, the at least one rod is engaged with the at least one latching member such that when the operating member is rotating around its own axis in the through hole, the at least one latching member is driven by the at least one rod to slide laterally.

17. The fixing device as claimed in claim 16, wherein each latching member comprises two plates extending upwardly with an interval defined by the two plates, the at least one rod is inserted into the interval.

18. The fixing device as claimed in claim 17, wherein the interval defined by the two plates of each latching member comprises a pair of distal ends and a middle portion between the distal ends, the movement of the operating member from one of the distal ends to the middle portion drives the hook portion to extend out of the opening portion, and the movement of the operating member from the middle portion to other one of the distal ends drives hook portion to be received in the opening portion.
